(19) United States
(12) Patent Application Publication
(10) Pub. No.: US 2024/0108921 A1
(43) Pub. Date: Apr. 4, 2024

(54) WEARABLE AIR PURIFIER

(71) Applicant: Dyson Technology Limited, Willshire (GB)

(72) Inventors: Emma Victoria CARSON, Swindon (GB); Stephen Benjamin COURTNEY, Gloucester (GB)

(73) Assignee: Dyson Technology Limited, Wiltshire (GB)

(21) Appl. No.: 18/267,751

(22) PCT Filed: Oct. 7, 2021
(86) PCT No.: PCT/GB2021/052600

§ 371 Date: Jun. 15, 2023

(30) Foreign Application Priority Data
Dec. 17, 2020 (GB) 2020006.9

(51) Int. Cl. A62B 18/00; A62B 18/08; A62B 23/02

(52) U.S. Cl. CPC A62B 18/006; A62B 18/003; A62B 18/084; A62B 23/02

(57) ABSTRACT

A wearable air purification system including one or more wearable supports and an air delivery mask supported by one or more of the one or more wearable supports. A motor for driving a flow of air to an air delivery region bounded by the air delivery mask is mounted at a first position on one of the one or more wearable supports, or at a first position on the air delivery mask. An air filter for purifying the flow of air is mounted at a second position on one of the one or more wearable supports.

### TECHNICAL FIELD

The disclosure is directed to improvements relating to wearable air purification systems or ‘purifiers’.

### BACKGROUND

We are all becoming more aware of air quality issues, particularly in larger urban areas but also more generally when in public areas where space between individuals may be limited, such as on public transport. Air quality issues may embrace various types of airborne pollutants such as potentially toxic gases and pollen, to name a couple of examples.

The wearing of various forms of face mask as a means to provide some level of protection against at least one form of airborne pollutants and toxins has generally become more accepted. However, usually such masks are passive and are configured simply as a single layer or multilayer assembly of material which is secured to the face of a user by an adjustable strap of some sort. Some people prefer to wear more complicated masks and respirators which offer a more comprehensive filtering functionality, but this usually comes at the expensive of comfort and style. They also are a barrier to clear communication.

Various approaches are apparent in the art that are intended to provide a similar or better level of air purification functionality, but which don't require a user to completely obscure their nose and mouth area by a tight-fitting mask. For example, one approach involves a wearable support such as a neckband or headband to which is attached a mask or visor which stretches around in front of the mouth and delivers a jet of filtered air. Such approaches show some promise over conventional fabric masks, but they still tend to obscure the user's facial features significantly. They also tend to be bulky which can sometimes be seen as limiting their practicality as an object for daily wear. The current disclosure is direct to addressing at least some of these challenges.

### SUMMARY OF THE INVENTION

According to a first aspect of the invention, there is provided a wearable air purification system comprising:
one or more wearable supports configured to be supported on a head region of a user;
an air delivery mask which is shaped to at least partially bound an air delivery region and which is configured to deliver a flow of air to the air delivery region in use, wherein the air delivery mask is supported by one or more of the one or more wearable supports;
a motor for driving the flow of air to the air delivery region, wherein the motor is mounted at a first position on one of the one or more wearable supports, or at a first position on the air delivery mask; and
an air filter for purifying the flow of air, wherein the air filter is mounted at a second position on one of the one or more wearable supports.

The wearable air purification system of the present invention is advantageous as the motor and the air filter may be positioned at different locations within the air purification device thus helping with optimisation of weight distribution and position of the centre of gravity, both of which are important to stability of the wearable air purification device in use.

Optionally, the motor and the air filter are spaced apart from one another. This is beneficial as it provides multiple packaging options.

The motor and the air filter may optionally be located adjacent to one another to minimise pressure drop in the flow of air between the motor and the filter.

In one example, the wearable support may be configured so that, in use, when said wearable support is supported on the head region of a user, the air filter is positioned towards the back of the user's head. This positioning of the air filter is beneficial as it helps to provide for a symmetrical airflow.

Optionally the motor is mounted on one of the one or more wearable supports, wherein said wearable support is configured so that, in use, when said wearable support is supported on the head region of a user, the motor is positioned towards the back of the user's head. Again, this positioning is beneficial as it helps to provide for a symmetrical airflow.

The wearable air purification system may optionally comprise a second motor mounted at a third position on one of the one or more wearable supports, or at a third position on the air delivery mask. The use of two or more motors is beneficial as it further helps with weight distribution and air flow control.

In one example, the wearable air purification system comprises a second air filter mounted at a fourth position on one of the one or more wearable supports, or at a fourth position on the air delivery mask. The use of two or more air filters is beneficial as it further helps with weight distribution and air flow control, and provides for enhanced levels of air purification.

Optionally one of the one or more motors may located between the air filter and the second air filter to provide pre and post filtering of the air flow.

The motor and the air filter may optionally be mounted on the same wearable support, wherein said wearable support is configured so that, in use, when said wearable support is supported on the head region of a user, the motor is substantially located on a first side of the user's head, and the air filter is substantially located on a second side of the user's head. This is beneficial for weight distribution design and packaging.

In one example the motor may be mounted on one of the one or more wearable supports, on the air delivery mask, or on both the air delivery mask and one of the one or more wearable supports. The ability to mount the motor or motors one the wearable support, the air delivery mask or on both the wearable support and the air delivery mask provides great flexibility of design choice to optimise both weight distribution and packaging considerations.

Optionally the wearable air purification system comprises two wearable supports, wherein the air delivery mask is supported by each of the wearable supports, and wherein each wearable support comprises a motor for driving the flow of air to the air delivery region mounted at the first position on each of the wearable supports, and an air filter for purifying the flow of air mounted at the second position on each of the wearable supports. The provision of two wearable supports allows for a design in which there may be a gap between the wearable supports. This may be of benefit to a user wishing to use the air purification system whilst driving or when wearing a ponytail for example.

The air delivery mask may optionally comprise a first air delivery channel located on a first side of the air delivery mask, and a second air delivery channel located on a second side of the air delivery mask, wherein the or each motor is configured to drive a flow of air to the air delivery region via both the first and second air delivery channels. This arrangement provides a symmetrical air flow to the user.

In one example, the air delivery mask comprises an air delivery channel substantially located on one side of the air delivery mask, wherein the or each motor is configured to drive a flow of air to the air delivery region via the air delivery channel. One sided airflow provides many addition design and packaging options.

Optionally the air delivery mask comprises an unsupported end. Such a design allows the users face to be left partially uncovered.

The or each motor may optionally be located downstream of the air filter, or the second air filter if present, such that the flow of air is prefiltered before entering the or each motor. Alternatively, the air filter, or the second air filter if present, is located downstream of a motor such that the flow of air is filtered after exiting the or each motor. The ability of optimise the relative position of the motor(s) and filter(s) is beneficial for optimisation of airflow, air purification, packaging, and weight distribution.

In one example the air delivery mask is integral with the or each wearable support to provide a streamlined and attractive product.

Optionally one of the one or more wearable supports may comprise a headband. A headband configuration for the wearable support is beneficial as it provides a fit similar to a set of headphones which a user may already be comfortable and familiar with wearing.

The wearable air purification system may optionally comprise an adjustable support band for facilitating support of the wearable air purification system on the head region of a user. The use of an adjustable support band provides additional security of fit. This may be of particular benefit to child users.

In one example, the wearable air purification system comprises at least one audio earpiece connected to one or more of the wearable supports thereby allowing the user to listen to musing or other audio whilst wearing the air purification device. Noise cancelling technology may also be used to lessen the noise of the motor(s) experienced by the user.

Optionally the wearable air purification system comprises first and second audio earpieces, wherein the first audio earpiece is connected to a first side of the wearable support and the second audio earpiece is connected to a second side of the wearable support, or the first audio earpiece is connected to a first wearable support and the second audio earpiece is connected to a second wearable support, wherein the first audio earpiece houses the motor, or the second motor if present, for driving the flow of air to the air delivery region, and the second audio earpiece houses the filter, of the second filter if present, for purifying the flow of air. This arrangement allows for greater packaging and weight distribution design options.

The air delivery mask optionally comprises one or more seals configured to conform to a portion of the user's face in use to help avoid loss of the purified air flow to the environment.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1 is a schematic side view of a user wearing an air purification system;

FIG. 2 is a schematic side view of a user wearing an air purification system having an alternative arrangement of components;

FIG. 3 is a schematic side view of a user wearing an air purification system having a further alternative arrangement of components;

FIG. 4 is a schematic plan view of a user wearing an air purification system having a still further alternative arrangement of components;

FIG. 5a is a schematic side view of a user wearing an air purification system having an alternative arrangement of components to the air purification systems shown in FIGS. 1 to 4;

FIG. 5b is a schematic plan view of a user wearing the air purification system of FIG. 5a;

FIG. 6 is a schematic plan view of a user wearing an air purification system having an alternative arrangement to the air purification systems shown in FIGS. 1 to 5;

FIG. 7 is a schematic plan view of a user wearing an air purification system having a further alternative arrangement to the air purification systems shown in FIGS. 1 to 5;

FIG. 8 is a schematic plan view of a user wearing an air purification system having a still further alternative arrangement to the air purification systems shown in FIGS. 1 to 5;

FIG. 9 is a schematic plan view of a user wearing an air purification system having yet a further alternative arrangement to the air purification systems shown in FIGS. 1 to 5;

FIG. 10 is a schematic plan view of a user wearing an air purification system having a further alternative arrangement to the air purification systems shown in FIGS. 1 to 5;

FIG. 11 is a schematic view of a user wearing an air purification system having a component located between two elements of the air purification system;

FIG. 12 is a schematic side view of the air purification system of FIG. 5a comprising an adjustable support band;

FIG. 13 is a schematic side view of the air purification system of Figure a comprising an audio earpiece;

FIG. 14a is a schematic plan view of the air purification system of FIG. 6 comprising an audio earpiece; and

FIG. 14b is a schematic plan view of an alternative arrangement of an air purification system comprising an audio earpiece.

Note that features that are the same or similar in different drawings are denoted by like reference signs.

### SPECIFIC DESCRIPTION

Examples of the invention will now be described in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview, the invention provides a wearable product or item that provides personal air purification in a convenient stylish package. The product, which will now be referred to as an air purifier, is configured to be worn by a user on or around the head so that the user can enjoy a ready source of clean filtered air.

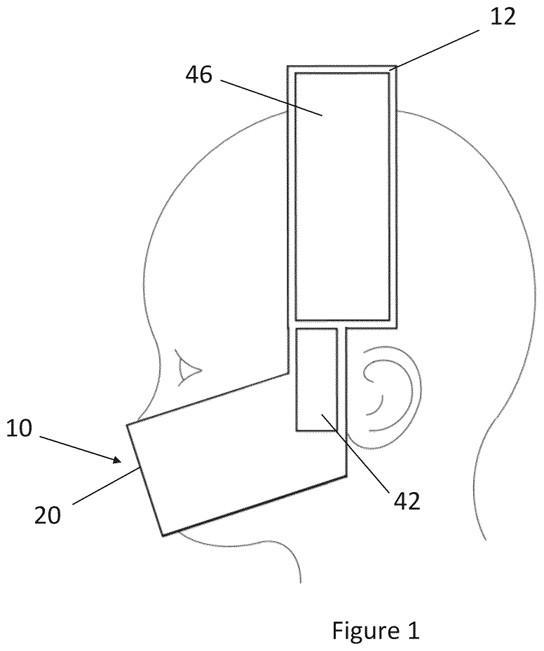

FIG. 1 shows a wearable air purification system, or air purifier, 10 comprising an air delivery mask 20 and a wearable support 12. In this example, the wearable support 12 comprises a headband which, when worn by a user as shown, extends from one side of the user's head to the other. The wearable support 12 is connected to the air delivery mask 20. The connection may be fixed so that the position of the wearable support 12 is fixed with respect to the air delivery mask 20. Alternatively, the wearable support 12 and air delivery mask 20 may be moveably connected to one another, for example by a pivoting connection, to allow the angular separation between the wearable support 12 and the air delivery mask 20 to be adjusted, and/or to allow the air purifier 10 to be reconfigured to have a smaller volume envelope to facilitate storage when not in use. In a further alternative example, the wearable support 12 and the air delivery mask 20 may be integral with one another.

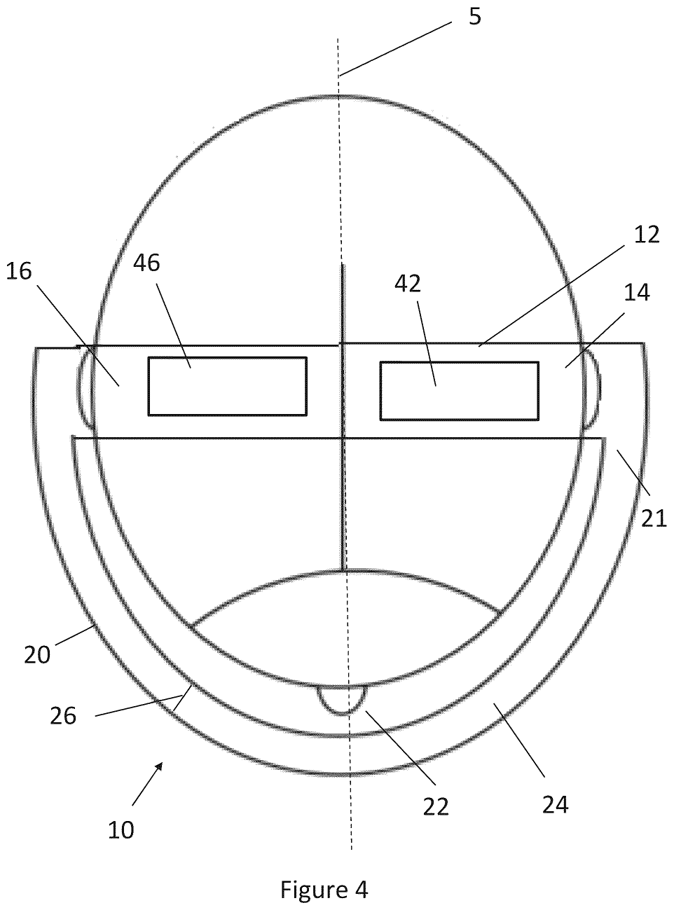

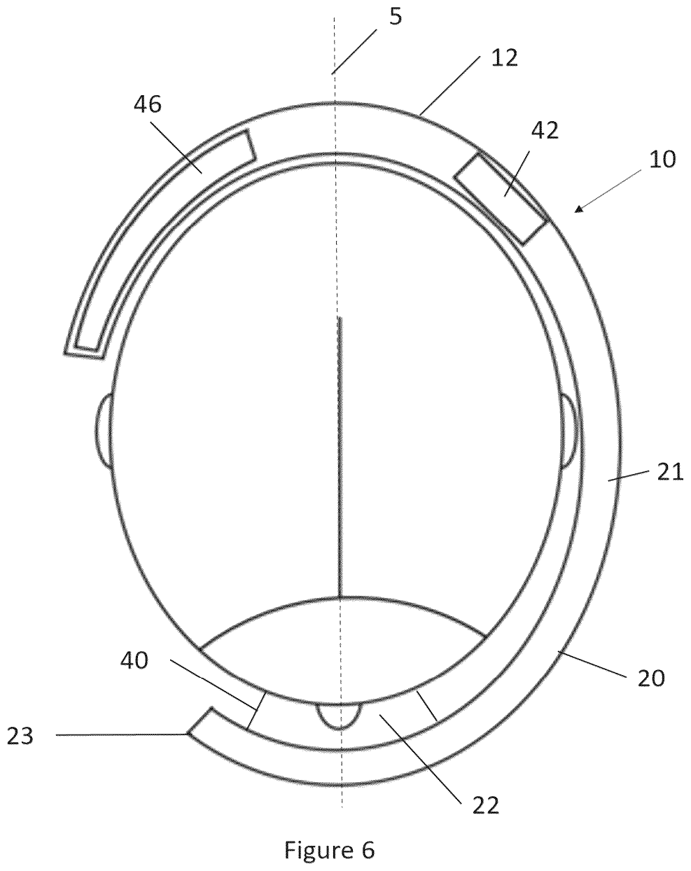

The air delivery mask 20 is configured to extend from one side of a user's face to the other in use so as to bound an air delivery region 22 located substantially in front of a user's mouth and/or nose (see FIG. 4 for example). The air delivery mask 20 may optionally include a conformable seal (see FIG. 6 for example) to isolate the air delivery region 22 from the atmosphere.

A motor 42 for driving a flow of air to the air delivery region 22 is mounted on the air delivery mask 20. The motor may drive a fan or a compressor (not shown) or the like. In this example, the motor 42 is mounted within the air delivery mask 20. However, in other examples, the motor 42 may be mounted on the outside of the air delivery mask 20.

An air filter 46 for purifying the flow of air is mounted on the wearable support 12. The air filter 46 is located upstream of the motor 42 so that the flow of air is filtered before it reaches the motor 42.

In the example of FIG. 1, The filter 46 is mounted within the wearable support 12 and a suitable air vent (not shown) is provided in the wearable support 12 to allow movement of atmospheric air into the air purifier 10. In an alternative example, the air filter 46 may be located on the outside of the wearable support 12. In each of the embodiments described herein, the motor 42 may be located within or on the wearable support 12 and/or air delivery mask 20.

In FIG. 1 the motor 42 and air filter 46 are positioned adjacent to one another but spaced apart from one another. It is not essential that the motor 42 be spaced apart from the air filter 46 and in other embodiments the motor 42 and the air filter 46 may contact one another.

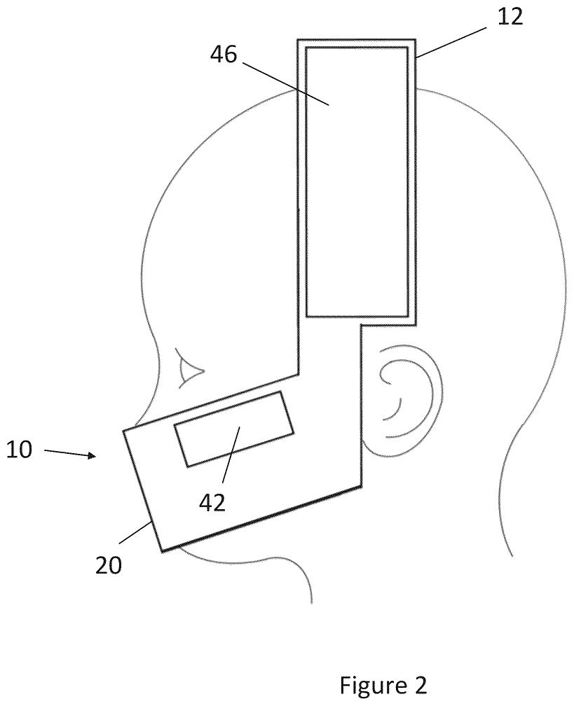

FIG. 2 shows an air purifier 10 having an alternative arrangement of components. In this example, the air filter 46 is mounted within the wearable support 12 as in the example described above in relation to FIG. 1. However, the motor 42 is mounted within the air delivery mask 20 such that it is no longer adjacent to the air filter 46. The motor 42 is located within the air delivery mask 20 in a position whereby, in use, when a user wears the air purifier 10, the motor 42 is positioned adjacent to the user's cheekbone forward of, and spaced from, the user's ear. This positioning of the motor 42 may be beneficial as it helps to reduce the noise of the motor experienced by the user. The position of the motor 42 with respect to the air filter 46, and other components (not shown) of the air purifier 10 may be selected during the design phase to tune the centre of gravity of the air purifier 10 to provide optimised balance and enhanced user comfort.

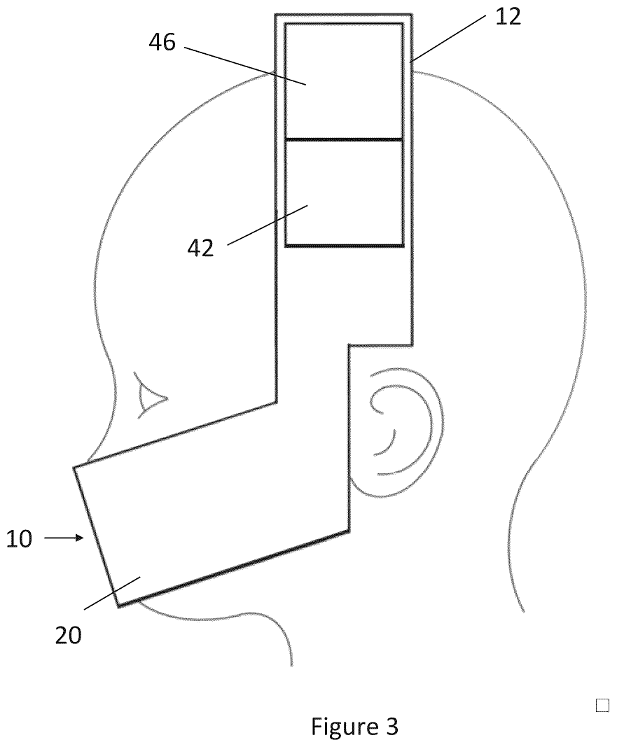

FIG. 3 shows an air purifier 10 having another alternative arrangement of components. In this example both the motor 42 and air filter 46 are located adjacent to one another within the wearable support 12. The skilled person will appreciate that the motor 42 and air filter 46 may be spaced further apart from one another if desired.

In all of the examples described above the motor 42 and air filter 46 are shown located on one side of the air purifier 10 such that they are located on one side of the user's head in use. This may be a desired layout for the air purifier 10. However, in an alternative example, the arrangements shown in FIGS. 1 to 3 may be mirrored on the other side of the air purifier 10 such that the air purifier has two motors 42 and two air filters 46. Alternatively, a single air filter 46 may be located centrally within the wearable support 12 and be configured to filter incoming air which is then drawn into the air purifier 10 by air movers connected to the motors 46. Any number of air filters 46 may be mounted on the wearable support 12, and any number of motors 42 may be mounted on the wearable support 12 and/or air delivery mask 20 as desired.

It should be noted that an asymmetric arrangement of the motor or motors 42 with respect to a centreline 5 of the air purifier 10 lends itself to an arrangement in which the air delivery mask 20 is configured to deliver the flow of air to the air delivery region 22 via one side of the air delivery mask 20 only (as will be described in greater detail below). Similarly, a symmetric arrangement of the motors 42 with respect to a centreline 5 of the air purifier 10 lends itself to an arrangement in which the air delivery mask 20 is configured to deliver the flow of air to the air delivery region 22 via both sides of the air delivery mask 20.

FIG. 4 shows a plan view of an air purifier 10 worn by a user. The air purifier 10 of this example has substantially the same overall arrangement as the air purifiers described above in relation to FIGS. 1 to 3. That is to say that the air purifier 10 of FIG. 4 comprises a wearable support 12 in the form of a headband which is connected to an air delivery mask 20 substantially as described above.

In the example of FIG. 4, both the air filter 46 and motor 42 are located within the wearable support 12 with the air filter 46 being located on one side of the centreline 5 of the air purifier 10, and the motor 42 being located on the other side of the centreline 5 such that the motor 42 is located on a first side 14 of the wearable support 12 and the air filter 42 is located on a second side 16 of the wearable support 12. The air delivery mask comprises an air delivery channel 24 which extends from a first end 21 of the air delivery mask 20 to the air delivery region 22. A wall 26 is located at the end of the air delivery channel 24 to prevent the filtered air flow from moving past the air delivery region 22 and into the opposite side of the air delivery mask 20. It should be noted that the wall 26 is not essential and may be omitted if desired.

In FIG. 4 the motor 42 is shown located downstream of the air filter 46. It will be understood that this arrangement could be reversed so that the air filter 46 is located downstream of the motor 42. Similarly, the motor 42 and air filter 46 are shown spaced apart from one another such that the motor 42 is located on one side of the user's head in use and the air filter 46 is located on the other side of the user's head in use. It will be understood that this arrangement could be modified such that the motor 42 and the air filter 46 are positioned adjacent to one another towards the centre of the wearable support 12 on either side of the centreline 5 such that the motor 42 is still located on one side of the user's head in use, and the air filter 46 is still located on the other side of the user's head in use. Alternatively, both the motor 42 and the air filter 46 may be located spaced apart from one another, or adjacent to one another, on the first or second side 14, 16 of the wearable support 12.

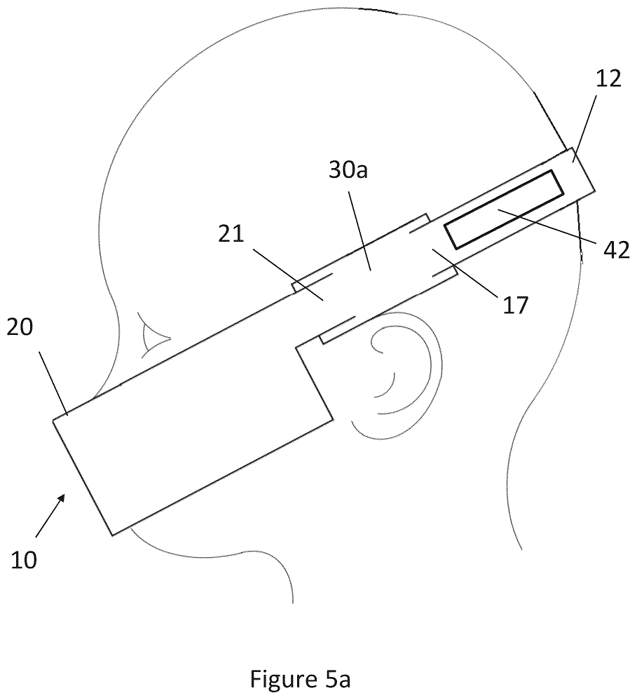

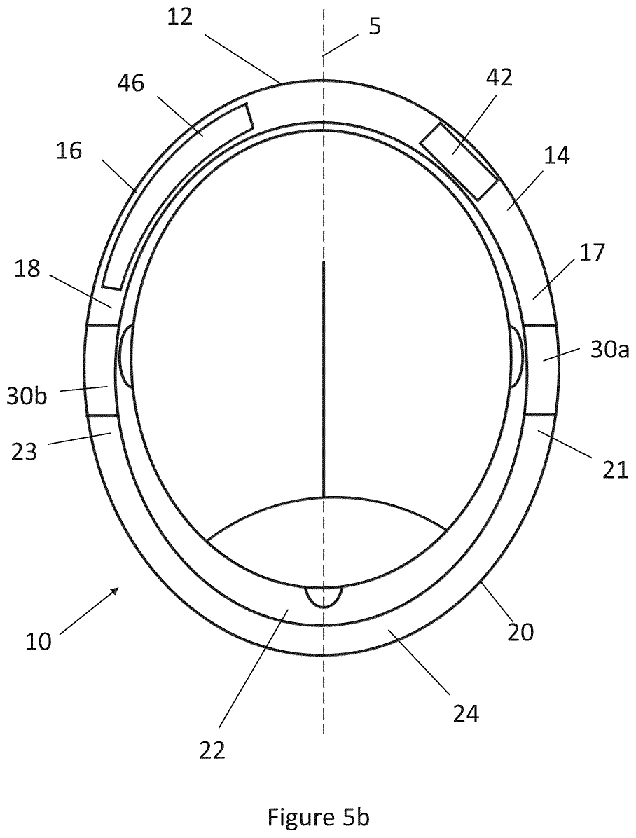

FIG. 5a is a schematic side view of a user wearing an air purifier 10 comprising a wearable support 12 that passes around the back of the head region of the user in use. FIG. 5b shows a schematic plan view of a user wearing the air purifier 10 of FIG. 5a.

In this example, the air delivery mask 20 is connected to the wearable support 12 by an intermediate support 30a. As shown in FIG. 5b, a corresponding intermediate support 30b is located on the other side of the air purifier 10. A first end 21 of the air delivery mask is slidably connected to the intermediate support 30a and a second end 23 of the air delivery mask 20 is slidably connected to the intermediate support 30b. Similarly, A first end 17 of the wearable support 12 is slidably connected to the intermediate connection 30a and a second end 18 of the wearable support 12 is slidably connected to the intermediate support 30b. The overall length of the air purifier is thereby adjustable by means of sliding the air delivery mask 20 and/or the wearable support 12 with respect to the intermediate supports 30a, 30b. This allows the air purifier 10 to be configured to suit the dimensions of the user's head. Although not shown in FIGS. 1 to 4, it will be understood that intermediate supports 30a, 30b with or without sliceable interfaces could be incorporated into the air purifiers shown in FIGS. 1 to 4.

It is not essential that the air purifier 10 of FIGS. 5a and 5b comprises the intermediate supports 30a, 30b and the wearable support 12 could be connected directly to the air delivery mask 20 in a fixed or slideable connection. In addition, the wearable support 12 could be pivotally connected to the air delivery mask 20 either directly or indirectly via one or more intermediate supports 30a, 30b. Finally, it will be understood that it is not essential that both the wearable support 12 and the air delivery mask 20 be connected to the intermediate supports 30a, 30b by slideable connections and that one or other of the wearable support 12 or air delivery mask 20 could be connected to the intermediate supports 30a, 30b by slideable connections while the other of the wearable support 12 or air delivery mask 20 is connected to the intermediate supports 30a, 30b by fixed or pivotable connections.

In the example of FIGS. 5a and 5b, the air filter 46 is located on one side of the air purifier 10 and the motor 42 is located, spaced from the air filter 46, on the other side of the air purifier 10. And as such, in use, the flow of air moves through the air filter 46, past the location of the motor 42 (moved by a suitable air mover connected to the motor 42) to the air delivery region 22. In this example, there is no dividing wall 26 (see FIG. 4).

In FIG. 5b the motor 42 is shown located downstream of the air filter 46. It will be understood that this arrangement could be reversed so that the air filter 46 is located downstream of the motor 42. Similarly, the motor 42 and air filter 46 are shown spaced apart from one another such that the motor 42 is located on one side of the user's head in use and the air filter 46 is located on the other side of the user's head in use. It will be understood that this arrangement could be modified such that the motor 42 and the air filter 46 are positioned adjacent to one another towards the centre of the wearable support 12 on either side of the centreline 5 such that the motor 42 is located on one side of the user's head towards the back of the user's head in use, and the air filter 46 is located on the other side of the user's head towards the back of the user's head in use. Alternatively, both the motor 42 and the air filter 46 may be located spaced apart from one another, or adjacent to one another, on the first or second side 14, 16 of the wearable support 12.

FIG. 6 shows a further alternative arrangement for an air purifier 10. The arrangement and positioning of the motor 42 and air filter 46 of the air purifier 10 shown in FIG. 6 are the same as those shown in the air purifier of FIGS. 5a and 5b. However, in this example the air delivery mask 20 is connected to the wearable support 12 only at its first end 21, the second end 23 of the air delivery mask 20 being unsupported. The air delivery mask of FIG. 6 may be connected to the wearable support 12 directly or indirectly via an intermediate support. As above, the connection between the air delivery mask 20 and the wearable support 12 may be fixed or moveable whether by direct or indirect connection.

The example air purifier 10 of FIG. 6 comprises an optional conformable seal 40 which is shaped to boarder the nose and mouth of a user and to form a substantially gas tight seal thereabout. The air delivery region 22 in this example is therefore bounded by the air delivery mask 20 and the conformable seal 40.

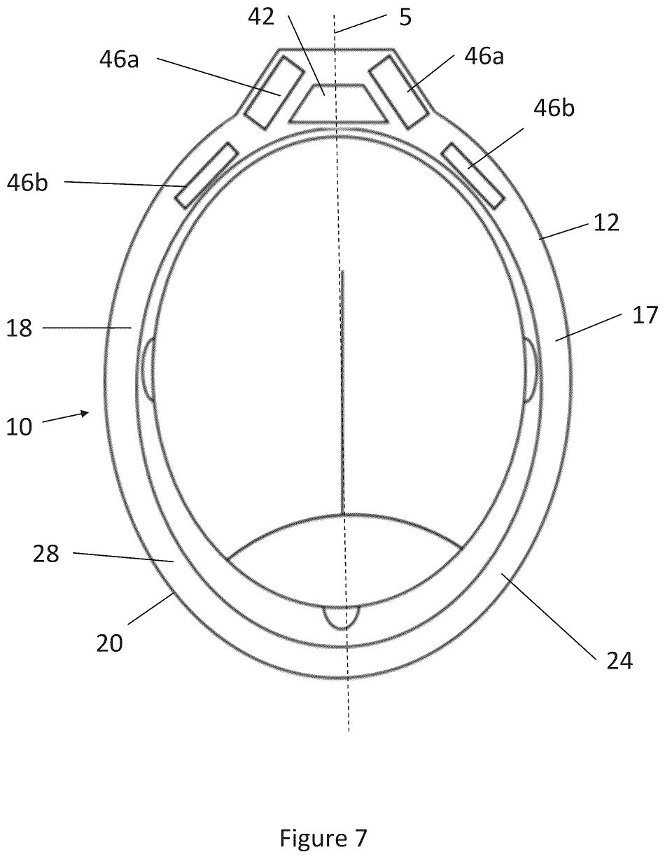

FIG. 7 shows another alternative arrangement for an air purifier 10. In this example, the motor 42 is located within the wearable support 12 approximately half way between the first and second ends 17, 18 of the wearable support 12 so that it is positioned towards the back of a user's head in use. This location of the motor 42 is advantageous as it is facilitates the location of the air mover (not shown) towards the centreline 5 of the air purifier 10 which positioning facilitates substantially equal delivery of the air flow to the air delivery region 22 via first and second air delivery channels 24, 28 in the air delivery mask 20.

The motor 42 is located between two air filters 46a located adjacent the motor 42. Two optional additional air filters 46b are located in the wearable support 12 downstream of the motor 42. The air filters 46a are positioned so that they filter the incoming air flow before it is driven towards the air delivery region 22 through the additional air filters 46b. In an alternative arrangement, one or other of the air filter pairs 46a, 46b may be omitted.

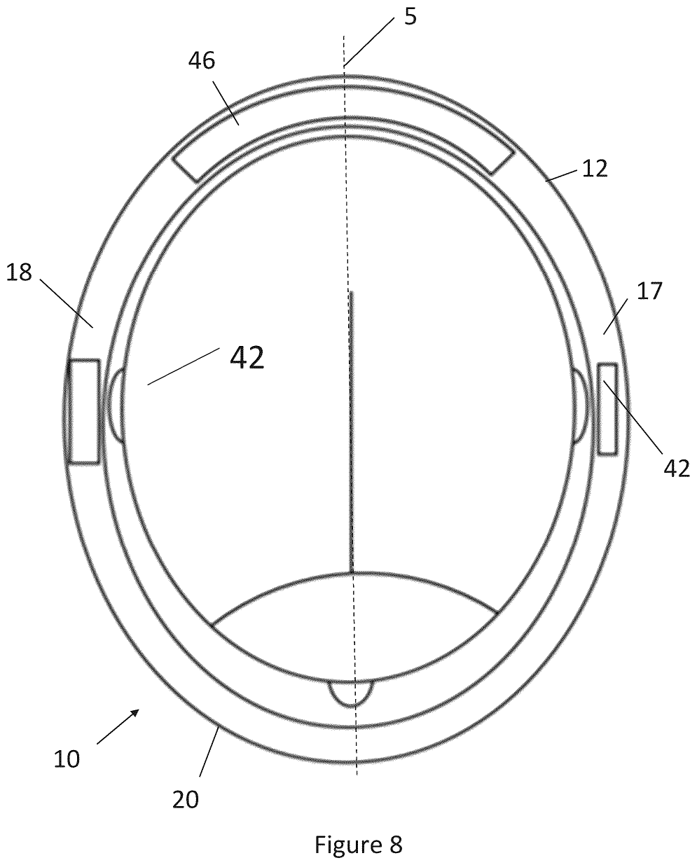

FIG. 8 shows a still further alternative arrangement for an air purifier 10. In this example, the air filter 46 is located within the wearable support 12 approximately half way between the first and second ends 17, 18 of the wearable support 12 so that it is positioned towards the back of a user's head in use. Two motors 42 are located in the wearable support 12 downstream of the air filter 46. In an alternative arrangement, one or other of the motors 42 may be omitted in which case the air flow is provided to the air delivery region 22 via one side of the air delivery mask 20 as described above in relation to FIGS. 4, 5a and 5b.

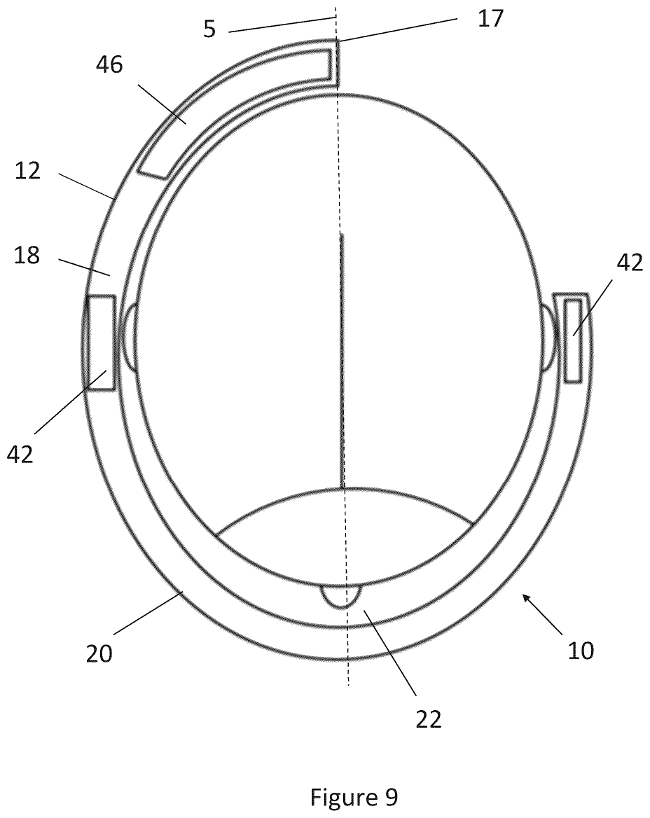

FIG. 9 shows another alternative arrangement for an air purifier 10. In this example, the wearable support is connected to the air delivery mask 20 only at its second end 18, the first end 17 of the wearable support 12 being unsupported. The air filter 46 is located within the wearable support 12 adjacent to the first end 17 of the wearable support 12, and the motor 42 is located in the wearable support 12 downstream of the air filter 46. In this example, as above, the air flow is provided to the air delivery region 22 via one side of the air delivery mask 20.

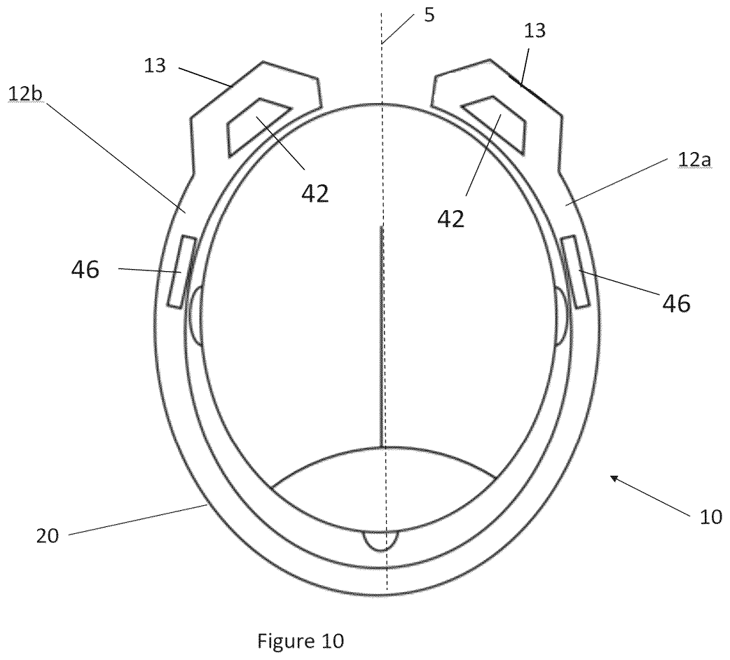

FIG. 10 shows a schematic plan view of an air purifier 10 having two wearable supports 12a, 12b connected to an air delivery mask 20. In this example, each wearable support 12a, 12b comprises a motor 42 located at a distal end 13 of the wearable support 12a, 12b, and an air filter 46 located between the motor 42 and the air delivery mask 20. In an alternative example, this arrangement could be reversed such that each wearable support 12a, 12b comprises an air filter 46 located at the distal end 13 of the wearable support 12a, 12b, and a motor 42 located between the air filter 46 and the air delivery mask 20. In each case, in use, when the air purifier 10 is worn by a user, either the motors 42 or air filters 46 are located towards the rear of the user's head.

In a further alternative example, a motor 42 could be located in one of the wearable supports and a filter 46 could be located in the other of the wearable supports. An air purifier 10 having such a configuration would benefit from the inclusion of a conformable seal 40 such as that described above in relation to FIG. 6 to optimise operation.

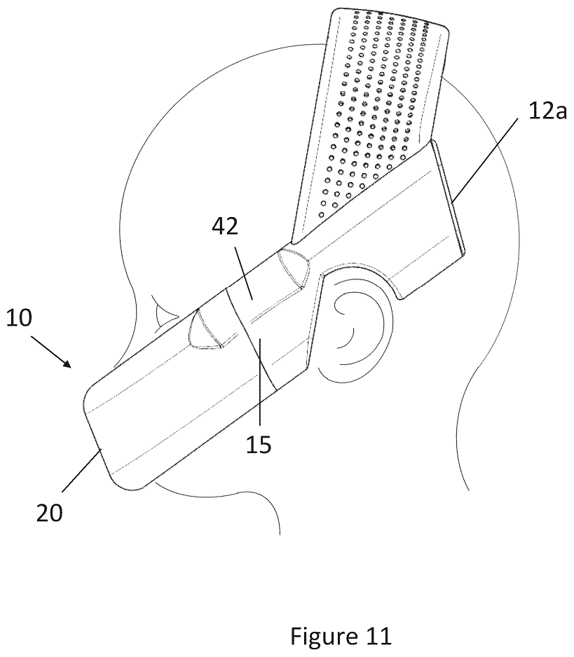

FIG. 11 shows a schematic perspective view of an air purifier 10 having much the same configuration as the air purifier described above in relation to FIG. 10. However, in this example, the motors 42 are located at a proximal end 15 of the wearable supports 12a, 12b and protrude into the air delivery mask 20. The motors 42 are supported by the wearable supports 12a, 12b. In an alternative example, the motors 42 may be supported by both the wearable supports 12 and the air delivery mask 20, or the motors 42 may be supported by the air delivery mask 20 alone. In each case, the air filters (not shown in FIG. 110 are located within the wearable supports 12a, 12b.

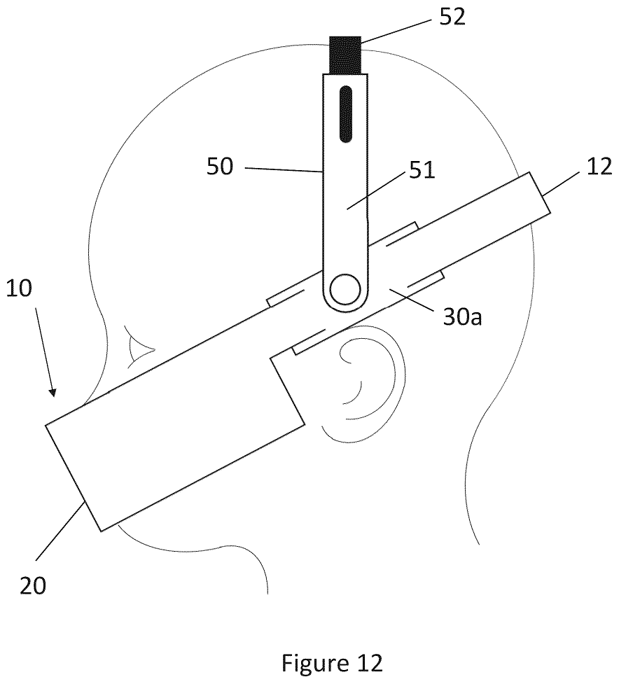

FIG. 12 shows a schematic side view of the air purifier 10 of FIG. 5a comprising an adjustable support band 50. The adjustable support band 50 comprises two side pieces 51 (only one shown in FIG. 12) and a connecting piece 52 which is slidably attached to one of the side pieces 51 to facilitate adjustment of the length of the support band 50. It will be understood that other mechanisms of length adjustability may be employed in the support band 50 and that the above is an example only.

The adjustable support band 50 is pivotally connected to the intermediate supports (only support 30a shown in FIG. 12) so that it may be positioned, in use, at a position that best suits the shape of the user's head.

An adjustable support band 50 may optionally be included with any of the example air purifiers described herein as an additional support for the air purifier 10 on the user's head. This may be beneficial, for example, for use during sports or for children whos' heads are still growing. It will be understood that the provision of an adjustable support band 50 is not essential and that the air purifiers described herein may be supported on the user's head without the need for a support band 50.

The pivotal connection of the adjustable support band 50 to the intermediate supports 30a, 30b shown in FIG. 12 is exemplary only. It will be understood that the adjustable support band 50 may be fixed to the air purifier 10 by any suitable means including a fixed connection or a pivotal and/or sliceable connection. In addition, the intermediate supports 30a, 30b are not essential to the use of an adjustable headband 50 and the adjustable headband 50 could connect directly to the wearable support 12 or air delivery mask 20.

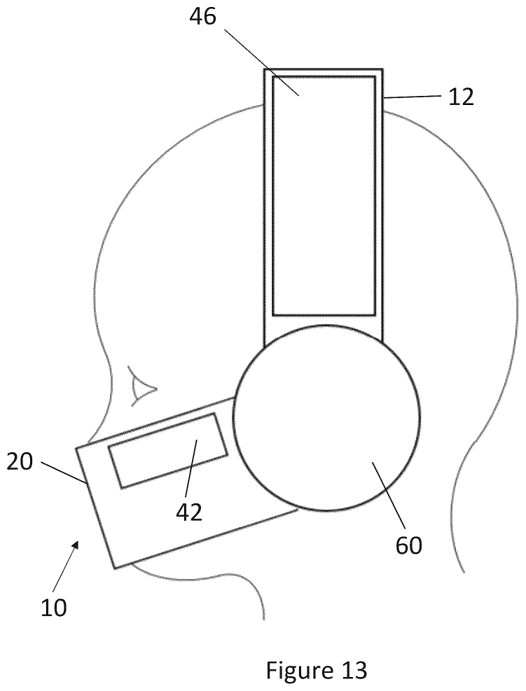

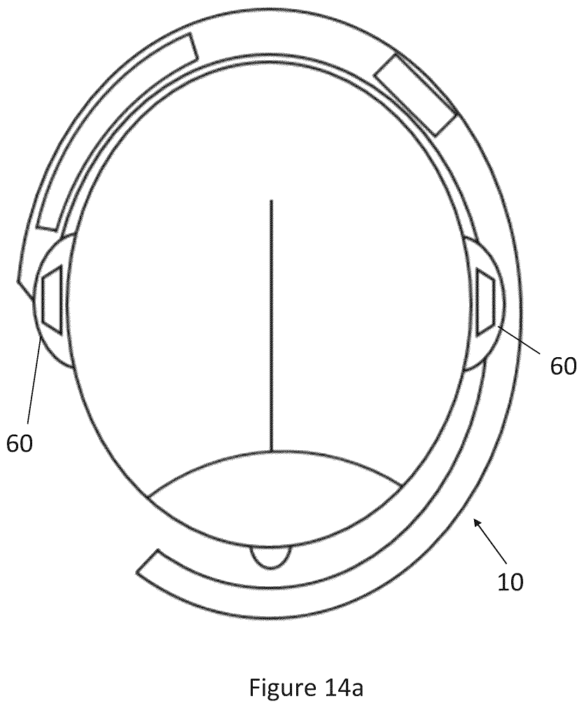

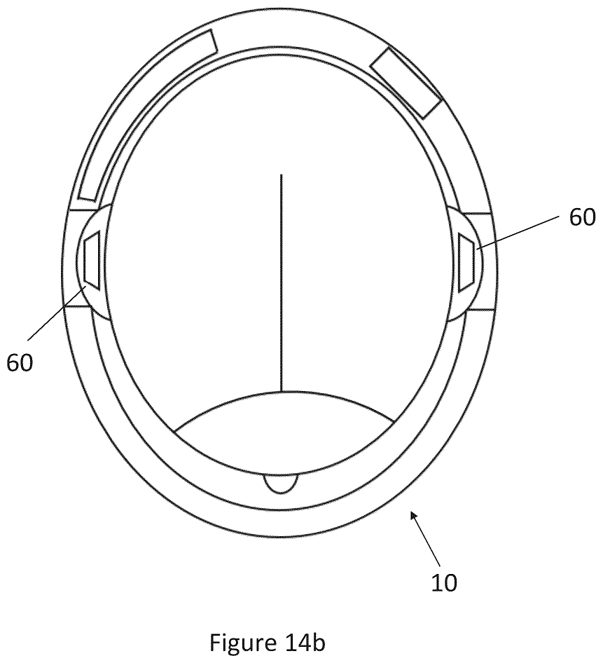

FIG. 13 shows an example of the air purifier 10 of FIG. 2 additionally comprising audio earpieces 60 located on each side of the air purifier 10 (only one shown in FIG. 13). Further examples of air purifiers 10 comprising audio earpieces 60 are shown in FIGS. 14a and 14b corresponding to the air purifiers of FIGS. 5b and 6 above.

It will be apparent to the skilled person that there are many possible layouts and arrangements for an air purifier 10 and that the above described embodiments are given as examples only and are not to be considered as limiting. In particular, it will be clear that the air delivery mask 20 and wearable support(s) 12 may be integral with one another or connected together directly or indirectly in a fixed or moveable connection. Similarly, it will be clear that motor(s) 42 and air filter(s) 46 may be arranged in the wearable support(s) and/or air delivery mask 20 in many different configurations.

1: A wearable air purification system comprising:
one or more wearable supports configured to be supported on a head region of a user;
an air delivery mask which is shaped to at least partially bound an air delivery region and which is configured to deliver a flow of air to the air delivery region in use, wherein the air delivery mask is supported by one or more of the one or more wearable supports;
a motor for driving the flow of air to the air delivery region, wherein the motor is mounted at a first position on one of the one or more wearable supports, or at a first position on the air delivery mask; and
an air filter for purifying the flow of air, wherein the air filter is mounted at a second position on one of the one or more wearable supports.

2: The wearable air purification system as claimed in claim 1, wherein the motor and the air filter are spaced apart from one another.

3: The wearable air purification system as claimed in claim 1, wherein the motor and the air filter are located adjacent to one another.

4: The wearable air purification system as claimed in claim 1, wherein said wearable support is configured so that, in use, when said wearable support is supported on the head region of a user, the air filter is positioned towards the back of the user's head.

5: The wearable air purification system as claimed in claim 1, wherein the motor is mounted on one of the one or more wearable supports, wherein said wearable support is configured so that, in use, when said wearable support is supported on the head region of a user, the motor is positioned towards the back of the user's head.

6: The wearable air purification system as claimed in claim 1, comprising a second motor mounted at a third position on one of the one or more wearable supports, or at a third position on the air delivery mask.

7: The wearable air purification system as claimed in claim 1, comprising a second air filter mounted at a fourth position on one of the one or more wearable supports, or at a fourth position on the air delivery mask.

8: The wearable air purification system as claimed in claim 7, wherein one of the one or more motors is located between the air filter and the second air filter.

9: The wearable air purification system as claimed in claim 1, wherein the motor and the air filter are mounted on the same wearable support, wherein said wearable support is configured so that, in use, when said wearable support is supported on the head region of a user, the motor is substantially located on a first side of the user's head, and the air filter is substantially located on a second side of the user's head.

10: The wearable air purification system as claimed in claim 1, wherein the motor is mounted on:
one of the one or more wearable supports; or
the air delivery mask; or
both the air delivery mask and one of the one or more wearable supports.

11: The wearable air purification system as claimed in claim 1, comprising two wearable supports, wherein the air delivery mask is supported by each of the wearable supports, and wherein each wearable support comprises a motor for driving the flow of air to the air delivery region mounted at the first position on each of the wearable supports, and an air filter for purifying the flow of air mounted at the second position on each of the wearable supports.

12: The wearable air purification system as claimed in claim 1, wherein the air delivery mask comprises a first air delivery channel located on a first side of the air delivery mask, and a second air delivery channel located on a second side of the air delivery mask, wherein the or each motor is configured to drive a flow of air to the air delivery region via both the first and second air delivery channels.

13: The wearable air purification system as claimed in claim 1, wherein the air delivery mask comprises an air delivery channel substantially located on one side of the air delivery mask, wherein the or each motor is configured to drive a flow of air to the air delivery region via the air delivery channel.

14: The wearable air purification system as claimed in claim 13, wherein the air delivery mask comprises an unsupported end.

15: The wearable air purification system as claimed in claim 1, wherein the or each motor is located downstream of the air filter, or the second air filter if present, such that the flow of air is prefiltered before entering the or each motor.

16: The wearable air purification system as claimed in claim 1, wherein the air filter, or the second air filter if present, is located downstream of a motor such that the flow of air is filtered after exiting the or each motor.

17: The wearable air purification system as claimed in claim 1, wherein the air delivery mask is integral with the or each wearable support.

18: The wearable air purification system as claimed in claim 1, wherein one of the one or more wearable supports comprises a headband.

19: The wearable air purification system as claimed in claim 1, comprising an adjustable support band for facilitating support of the wearable air purification system on the head region of a user.

20: The wearable air purification system as claimed in claim 1, comprising at least one audio earpiece connected to one or more of the wearable supports.

21: The wearable air purification system as claimed in claim 20, comprising first and second audio earpieces, wherein:
the first audio earpiece is connected to a first side of the wearable support and the second audio earpiece is connected to a second side of the wearable support; or
the first audio earpiece is connected to a first wearable support and the second audio earpiece is connected to a second wearable support
wherein the first audio earpiece houses the motor, or the second motor if present, for driving the flow of air to the air delivery region, and the second audio earpiece houses the filter, of the second filter if present, for purifying the flow of air.

22: The wearable air purification system as claimed in claim 1, wherein the air delivery mask comprises one or more seals configured to conform to a portion of the user's face in use.
